(19) United States
(12) Patent Application Publication
(10) Pub. No.: US 2008/0232916 A1
(43) Pub. Date: Sep. 25, 2008

(54) Process and Device for Producing Threads, Especially for Boring Rods or the Like

(76) Inventor: Harry Schiemann, Schaffhausen (CH)

Correspondence Address: MCGLEW & TUTTLE, PC, P.O. BOX 9227, SCARBOROUGH STATION, SCARBOROUGH, NY, 10510-9227, US

(21) Appl. No.: 11/997,024

(22) PCT Filed: Jul. 22, 2006
(86) PCT No.: PCT/EP06/07228

§ 371 Date: Jan. 28, 2008

(30) Foreign Application Priority Data
Jul. 29, 2005 (DE) 10 2005 035 576.5

(51) Int. Cl. B23C 3/32; B23B 1/00

(52) U.S. Cl. 409/66; 82/110

(57) ABSTRACT

The present invention proposes a process for producing threads, especially for boring rods or the like, wherein the workpiece and the lathe tool have a relative rotary motion at a high velocity about an axis of the workpiece and a relative longitudinal motion at a low velocity compared to the above velocity, and wherein an oscillating radial relative rotary motion is brought about, furthermore, between the lathe tool and the workpiece, wherein the radial oscillating motion is generated mechanically, the radial oscillating motion being synchronized, in particular, with the relative rotary motion. The present invention pertains, furthermore, to a device for producing threads by a means for generating the radial mechanical oscillating motion, where the radial oscillating motion is synchronized, in particular, with the relative rotary motion.

### CROSS REFERENCE TO RELATED APPLICATIONS

This application is a United States National Phase application of International Application PCT/EP2006/007228 and claims the benefit of priority under 35 U.S.C. § 119 of German Application DE 10 2005 035 576.5 filed Jul. 29, 2005, the entire contents of which are incorporated herein by reference.

### FIELD OF THE INVENTION

The present invention pertains to a process for producing threads, especially for boring rods or the like, wherein the workpiece and the lathe tool have a relative rotary motion at a high velocity about an axis of the workpiece and a relative longitudinal motion at a low velocity compared to the above velocity, and wherein a relative radial oscillating motion is, furthermore, brought about between the lathe tool and the workpiece, as well as to a device for producing threads, especially for boring rods or the like, with means for generating a relative rotary motion at a high velocity about the axis of a workpiece between this and a lathe tool and for generating a relative longitudinal motion at a low velocity compared to the above velocity between the lathe tool and the workpiece, as well as with a means for generating the relative radial oscillating motion between the workpiece and the lathe tool.

### BACKGROUND OF THE INVENTION

Threads are usually produced by thread cutting, which can be carried out by means of a lathe working to attain the desired depth of thread, and these may be up to 40 passes per thread. It is, furthermore, disadvantageous during thread cutting that long metal chips are formed, which are difficult to control.

It was proposed, furthermore, contrary to thread cutting, to prepare the production of a thread by turning, when a radial oscillating motion is imposed on the lathe tool by the electronic control of a corresponding motor.

It is possible to work at velocities of up to a maximum of 300 rpm in case of the motions necessary for producing a thread by means of turning with the electronic control and synchronization, because higher rpms cannot be synchronized by means of the digital electronic system provided. Synchronization problems and hence profile distortions develop, which cause workpieces machined at higher velocities to be unfit for use. Limits are thus set to increasing the productivity of thread production by turning compared to thread cutting.

### SUMMARY OF THE INVENTION

The basic object of the present invention is therefore to provide a process and a device for producing threads, with which the threads can be produced in one pass at high rpms and it is possible to greatly increase the productivity.

The object is accomplished according to the present invention with a process of the type described in the introduction, which is characterized in that the radial oscillating motion is generated mechanically. To accomplish the object, the present invention provides, furthermore, a device, which is characterized by a means for generating the radial mechanical oscillating motion. The basic shape of the thread is thus produced purely mechanically.

The process according to the present invention is based on a turning process with pitch-dependent feed and on the generation of the thread profile with the use of a rotating cam plate, which acts directly on the radial feed of the tool. The rotary motions of the workpiece and of the cam plate are synchronized now such that a thread with the desired pitch and direction is obtained from the relative motions of the rotating workpiece and the oscillating tool. The thread profile is determined by the shape of the cam. Depending on the stability of the tool, the threads are turned to the finished state up to a depth of thread of several mm, especially 3 mm, which represents an advantage of the process in terms of productivity, contrary to conventional thread cutting that does not belong to this class, in which the thread is generated by the longitudinal motion of the tool synchronously with the thread pitch with stepwise feed of the tool in the depth of thread, wherein a greater number of passes are necessary for this, depending on the profile size, and the number of passes is also determined by the nature of the workpiece and the quality of the tool.

Various thread shapes can be produced by means of the present invention with cylindrical and conical basic shape of the workpiece, and the tooth forms may be R threads (rope threads) or also trapezoidal threads, especially in the form of a flat trapezoid. The present invention is especially suitable for producing connection threads of tube rods.

Provisions are made in a preferred embodiment for the radial oscillating motion to be synchronized with the relative rotary motion, and the ratio F is calculated, independently of the frequency of the oscillating motion to the rpm of the relative rotary motion, according to

$$F = \frac{S / V}{S / V \pm 1} ,$$

in which S denotes the pitch of the thread in mm and V the feed of the relative longitudinal motion in mm per revolution. The values of the numerator and denominator are preset for the control of the lathe, after which the latter automatically calculates the synchronization factor. The value (+1) indicates a right-hand thread and the value (−1) a left-hand thread.

Provisions are made in other preferred embodiments of the process and of the device for the radial oscillating motion to be brought about by means of a cam plate and by the mechanical means for generating the radial oscillating motion to be a cam plate.

The machining operation is divided by the present invention into a simple and proven mechanical generation of the thread profile and a linear, electronic synchronization for generating the thread pitch, as well as the use of the X slide of a lathe for generating the thread cone. The production of the cam shape for generating the thread profile can be carried out on conventional coordinate grinding machines or on milling machines. A changeover to different thread shapes is possible in a simple manner by replacing the cams and the part program. Because of the soft profile change of the disks (thread transitions with radii), it is possible to work with a spindle velocity of up to approximately 1,000 rpm.

It is possible due to the present invention to work at a relative rpm between 800 and 1,000 rpm, and the workpiece is, as a rule, usually rotated. The axial longitudinal feed of the tool relative to the workpiece is on the order of magnitude of 0.15 to 0.25 mm per revolution and preferably 0.2 mm per revolution. The thread is produced in one pass, and its precision can be readily checked. The thread profile can be produced by the present invention in one pass, so that separate roughing and finishing can be done away with. Perfect formation of a cutting is obtained. Due to the oscillation of the tool, a chip with increasing and decreasing thickness is formed during each revolution, and this chip breaks reliably at the thinnest point and facilitates removal from the drilled hole by blowing out or flushing out above all in case of internal threads.

There are approximately 5 to 8 turns per 10 cm of length in such boring rod threads, depending on the thread diameter.

The device according to the present invention for producing threads, which is, however, a usual lathe per se with the means according to the present invention for generating the oscillating motion, may be a counter spindle lathe, so that two workpieces can be machined simultaneously, especially when threads of opposite thread directions are to be produced, the term “opposite thread directions” being used in the sense that both threads are turned from their respective input side, for example, in the case of internal threads on a sleeve.

Provisions are made according to a preferred embodiment of the process according to the present invention for the lathe tool being moved relative to the workpiece by means of the cam plate, the lathe tool being, furthermore, moved against the spring force of a spring by the cam plate. Provisions are made in a concrete embodiment for the lathe tool to be attached to a plunger, which is moved by the cam plate towards the workpiece against the spring force and returned under the action of the spring.

Consequently, provisions are made in a variant of the device according to the present invention for the lathe tool to be able to be put into a radial oscillating motion by means of the cam plate, a spring being provided, in particular, for pressing a plunger carrying the lathe tool elastically against the cam plate and for a drive shaft to be connected to the drive for the longitudinal motion during the operation.

The shape of the cam plate necessary for producing the thread can be derived from the profile of the particular thread by recording this and dividing into sections in the longitudinal direction. A resolution better than 5° can be obtained. Taking the tool contour into account, the sections are transformed into radial displacements as a basis for the shape of the cam plate.

When producing the cam plate from the blank, the disk profile can be produced on a numerically controlled milling machine, the cam radii determined in the CAD being used directly for programming. Because of the relatively coarse resolution, the intermediate values are interpolated via spline functions, which are already part of modern CNC controls.

The various features of novelty which characterize the invention are pointed out with particularity in the claims annexed to and forming a part of tis disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view of a counter spindle lathe with two treading means;

FIG. 2 is a schematic perspective view of a treading means according to the present invention;

FIG. 3 is a longitudinal sectional view through the threading means according to FIG. 2;

FIG. 4 is a side view of the essential parts of a threading means with a tool for the external machining of a hollow tube;

FIG. 4a is a view corresponding to that in FIG. 4, with a tool for internal machining (however, in a view opposite to that in FIG. 3);

FIG. 5 is a sectional view corresponding to V-V through the cam unit of the threading means;

FIG. 5a is a sectional view corresponding to A-A in FIG. 5 through the cam unit;

FIG. 6 is a sectional view corresponding to VI-VI in FIG. 5a through the cam unit;

FIG. 7 is a side view of a cam plate for producing a so-called R thread (rope thread with a thread contour that is sinusoidal in the longitudinal section);

FIG. 7a is an illustration of producing an R thread by means of the cam plate according to FIG. 7;

FIG. 8 is a side view of a cam plate for producing a T thread (trapezoidal thread);

FIG. 8a is an illustration of a T thread by means of the cam plate according to FIG. 8; and

FIGS. 9a is a cross sectional view of trapezoidal threads of the screw portion of a rod thread; and

FIG. 9b is a cross sectional view of the nut portion of a rod thread.

### DESCRIPTION OF THE PREFERRED EMBODIMENTS

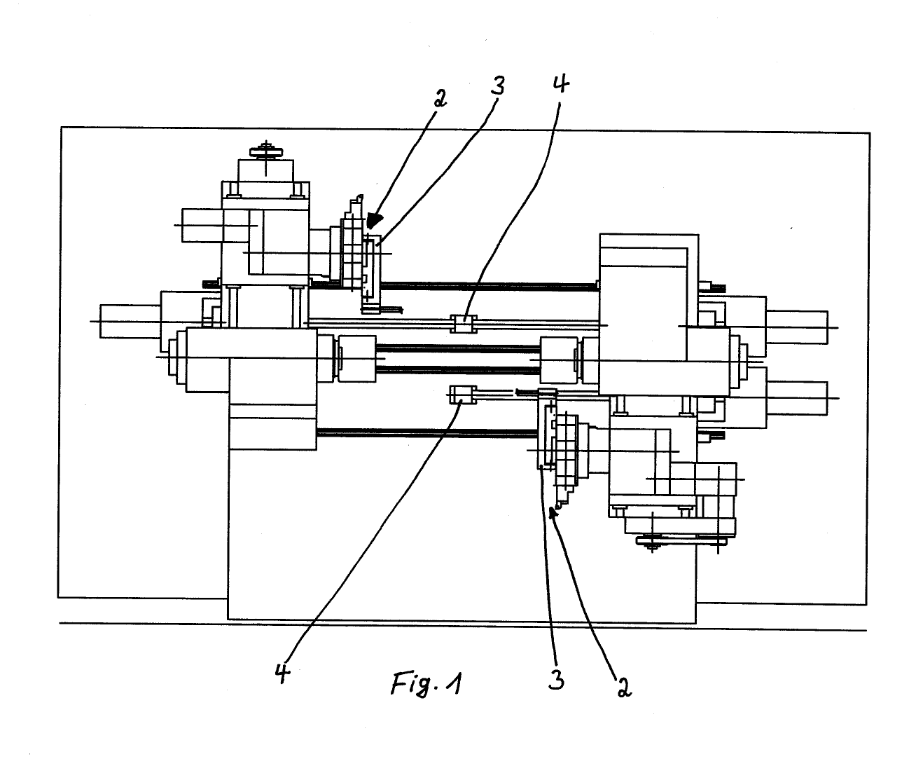

Referring to the drawings in particular, FIG. 1 shows a schematic view of a lathe 1 with two threading means 2, so that two threads can be turned simultaneously on this lathe. Lathe tools 4 are arranged on the threading means 2 at the cam part 3.

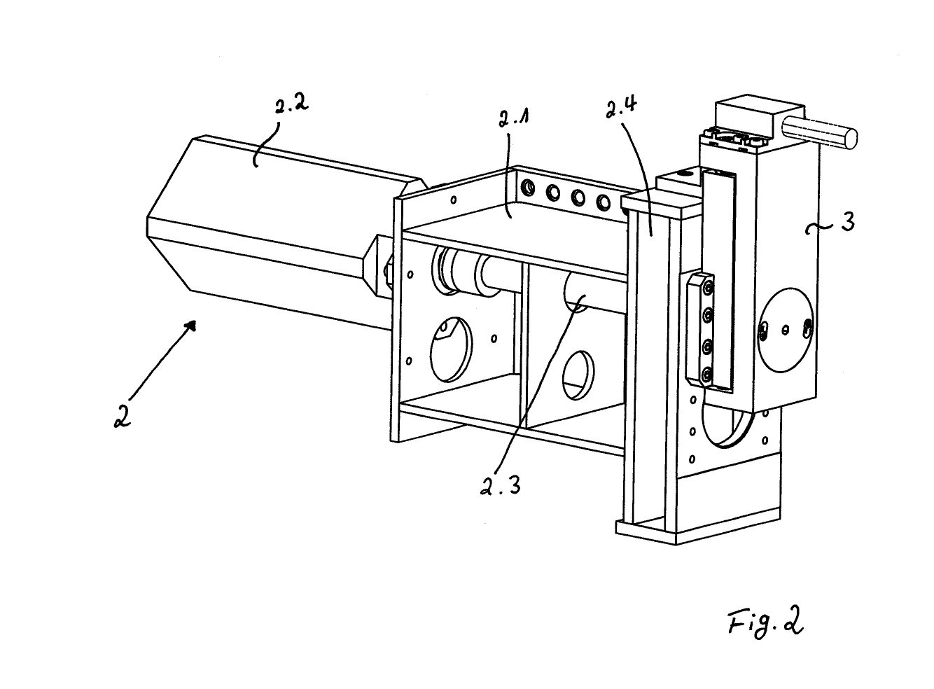

FIG. 2 shows a perspective view of a threading means 2 with a holding part 2.1, a motor operator acting as a drive motor 2.2, a drive shaft 2.3, a coupling unit 2.4, and the cam unit 3 proper.

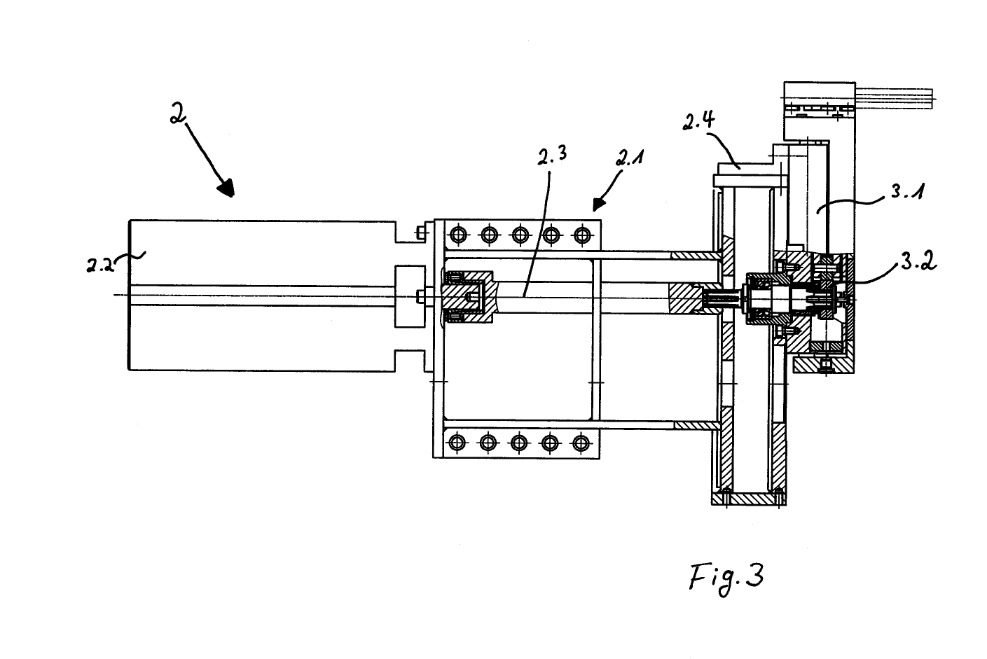

FIG. 3 shows a longitudinal section through the threading means 2 according to FIG. 2, wherein the parts already named are named in the same manner.

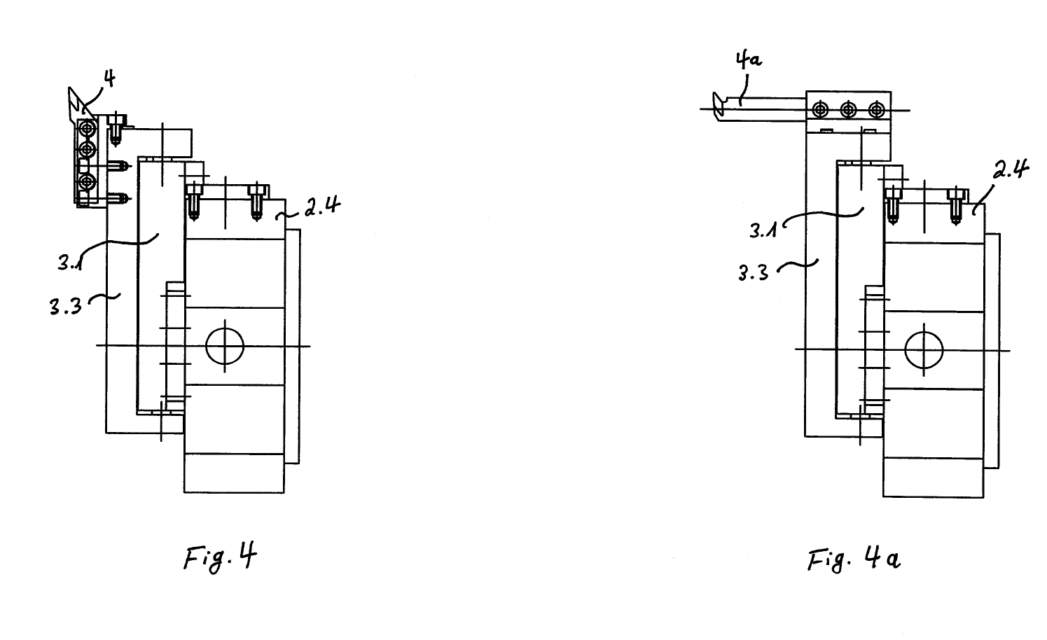

The cam unit has a holding part 3. 1, which is rigidly connected to the coupling unit 2.4 and in which a cam plate 3.2 connected to the shaft 2.3 is rotatable. The holding part 3.1 carries, in a manner yet to be described more specifically, a slide 3.3, which can be displaced at right angles to the axis of the cam plate 3.2 and in the longitudinal direction of the holding part 3.1, and which carries a lathe tool 4 (not shown in FIG. 3; see FIGS. 1, 4 and 5), namely, the tool 4 shown for external machining in FIG. 4 and a tool 4 a for internal machining in the embodiment shown in FIG. 4a.

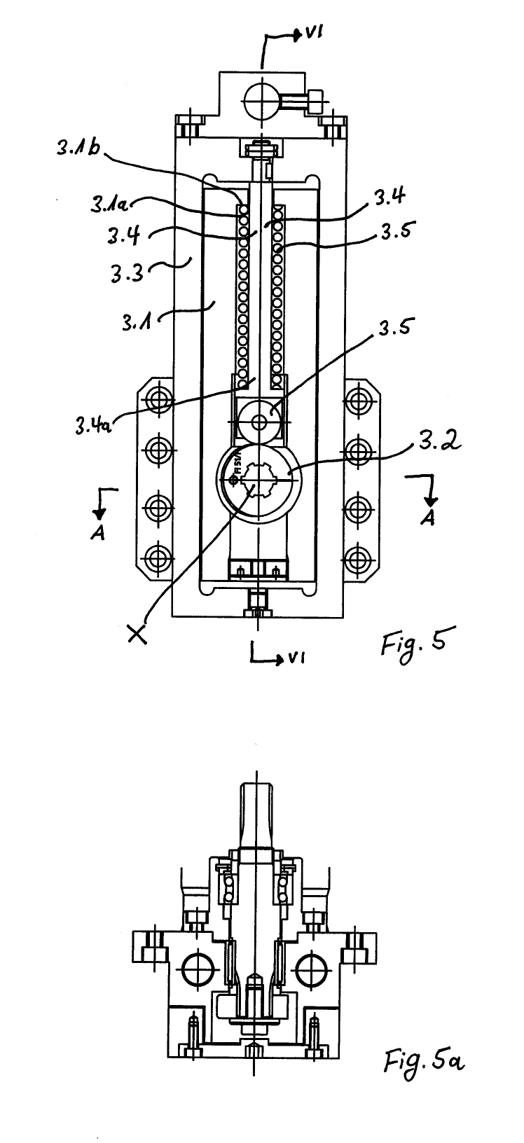

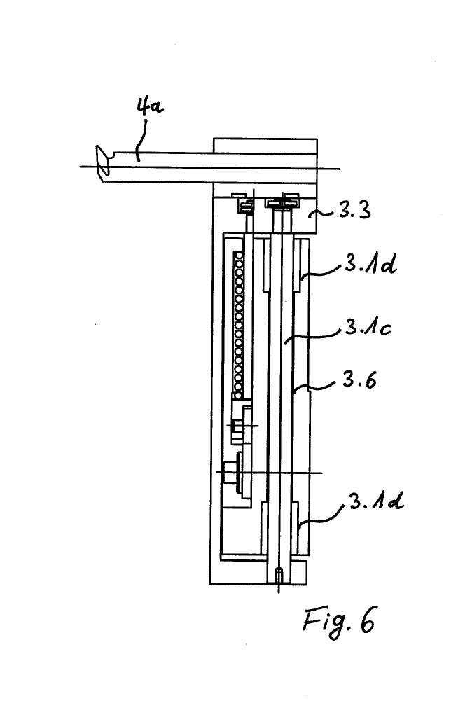

As can be determined from FIG. 5, a plunger, on which a roller 3.5, which is in rolling contact with the cam plate 3.2, is mounted at its lower end, is located within the holding part 3.1 in a longitudinal recess 3.1 a thereof, the plunger being movable in the longitudinal direction of the holding part 3.1 and of the longitudinal recess 3.1a and hence at right angles to the axis x of the cam plate 3.2. A restoring spring 3.5, designed as a coil spring, which correspondingly presses the plunger 3.4 against the cam plate 3.2, is arranged between an upper shoulder 3.1b of the holding part 3.1 and an abutment 3.4 in the form of a radial flange. The plunger 3.4 is connected in a positive-locking manner to the already mentioned displaceable slide 3.3, which carries a lathe tool 4 or 4a (FIGS. 4, 4a) on its upper side. Furthermore, the slide is connected to two guide bars 3.6, which are slidable with close tolerances in other recesses 3.1c of the holding part 3.1 and are guided by ball-type nipples 3.1d located at the upper and lower ends of the holding part 3.1. The two guide bars 3.1c and the plunger 3.4 form the cross section (FIG. 6).

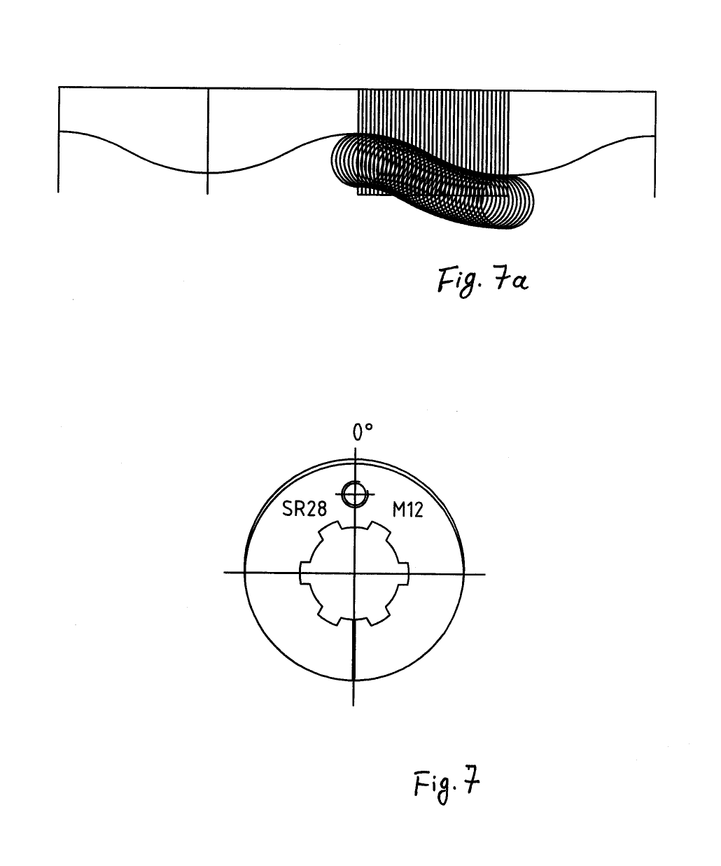

FIG. 7 shows a cam plate approximately on a scale of 1:1, while FIG. 7a illustrates how a screw thread is produced by the mechanical turning operation along a workpiece by the up and down motion of the lathe tool 4, 4 a based on the motion of the plunger 3.4 and of the slide 3.3. The circles shown correspond to the radius of the lathe tool.

When considering cross sections of a thread at any desired point, a cut surface is obtained, depending on the type of thread, which is repeated in case of shifting in the axial direction, but rotated by an angle, which is obtained from the ratio of the Z feed to the thread pitch. At a pitch S of 12.7 mm and a feed of 0.25 mm per revolution, this means a rotation of (0.25/12.7)×360=7.087° of the thread between two sections located next to each other, being positive or negative depending on the direction of the pitch (right-hand or left-hand).

The profile of the cut surface is produced according to the present invention by the oscillating tool 4, 4a, whose radial motion is generated by the circulating cams. The rpm of the cam is synchronized with the rpm of the workpiece such that continuous rotation of the cut surfaces takes place. Related to the above example, factors of 1.02008 and 0.98069 are obtained, depending on the direction of pitch. In principle,

$$F = \frac{S / V}{S / V \pm 1} ,$$

in which S is the pitch of the thread in mm and V is the feed of the relative longitudinal motion in mm/revolution.

The feed motion to the depth of thread as well as the production of a conical thread is brought about by the X slide present in the lathe as a carrier of an additional slide. This slide is arranged on the front side of the revolver disk of the lathe and is driven through the revolver pivot axis with a motor operator, which is synchronized with the main spindle in the described form.

Even though the production of the thread can take place, in principle, in one operation, the threads may also be produced, if necessary, in two passes (roughing and finishing). This requires the use of different feeds and a corresponding adaptation of the programmable synchronization factor.

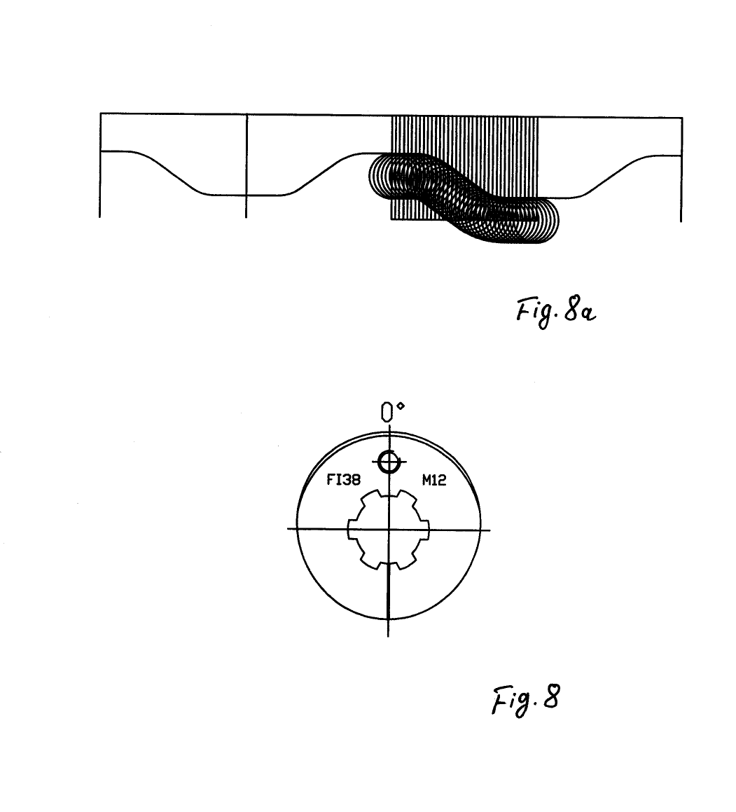

While the cam plate according to FIG. 7 is used, as this is apparent from FIG. 7a, to produce an R thread, i.e., a rope thread, FIG. 8 shows a cam plate for producing a T thread or trapezoidal thread, as this is apparent from FIG. 8a. It can be recognized that the cam area of the cam plate according to FIG. 7 extends over 180°, while it extends over an angle smaller than 180° in the embodiment according to FIG. 8 and the rest is formed by an arc of a circle.

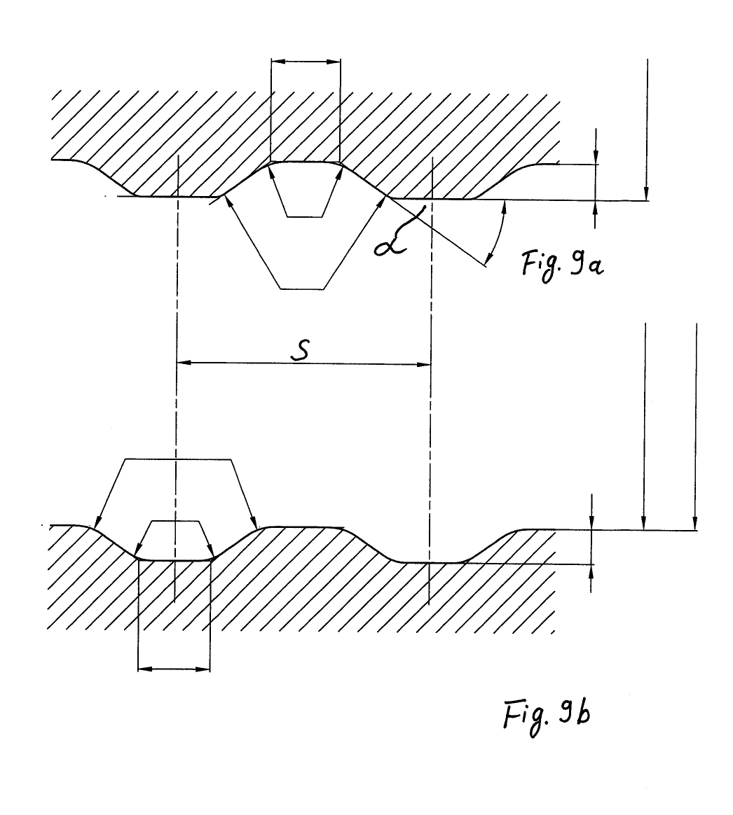

FIGS. 9a and 9b illustrate, in a comparison, threads that cooperate with one another on two workpieces that can be coupled by screwing, namely, a “male” part (FIG. 9a) with an external thread and a corresponding “female part” with a corresponding internal thread (FIG. 9b), α being the thread angle of approximately 35° and S being the pitch of the thread.

The threads are produced by turning, by the workpiece being rotated at a high velocity during the production of an external thread and the longitudinal slide being moved at the same time with a small axial feed, while the lathe tool 4 is moved up and down at a velocity coordinated with the velocity of feed by the cam plate, so that when the workpiece is located above the lathe tool, the bottom of the groove or wave of the screw thread is produced in the upper position of the tool and the groove or wave peak of the screw thread is produced in the area of the lower position of the lathe tool, the screw thread being formed due to the feed of the workpiece and of the lathe tool being coordinated with one another in a certain manner, preferably according to the coordination already mentioned above.

While specific embodiments of the invention have been shown and described in detail to illustrate the application of the principles of the invention, it will be understood that the invention may be embodied otherwise without departing from such principles.

1. A process for producing threads, especially for boring rods or the like, the process comprising:
turning a workpiece and a lathe tool such that said workpiece and said lathe tool have a relative rotary motion at a first velocity about an axis of the workpiece and a relative longitudinal motion at a second velocity, said first velocity being greater than said second velocity;
generating a relative radial oscillating motion between the lathe tool and the workpiece;
mechanically synchronizing said radial oscillating motion with said relative rotary motion.

2. Process in accordance with claim 1, wherein the radial oscillating motion is synchronized with the relative rotary motion.

3. Process in accordance with claim 2, wherein the ratio F of the frequency of the oscillating motion to the rpm of the relative rotary motion is
$$F = \frac{S / V}{S / V \pm 1} ,$$
wherein S denotes the pitch of the thread in mm and V denotes the feed of the relative longitudinal motion in mm per revolution.

4. Process in accordance with claim 1, wherein a cam plate produces the radial oscillating motion.

5. Process in accordance with claim 4, wherein the lathe tool is moved relative to the workpiece by said cam plate.

6. Process in accordance with claim 4, wherein the lathe tool is moved by the cam plate against a spring force of a spring.

7. Process in accordance with claim 5, wherein the lathe tool is attached to a plunger, which is moved by the cam plate against the spring action to the workpiece and returned under the action of the spring.

8. A device for producing threads, especially for boring rods or the like, the device comprising:
a means for turning a lathe tool and a workpiece such that the lathe tool and the workpiece generate a relative rotary motion at a first velocity about the axis of a workpiece and for generating a relative longitudinal motion at a second velocity, said second velocity being less than said first velocity;
a means for generating a relative radial oscillating motion between the workpiece and the lathe tool;
a mechanical means for mechanically synchronizing the radial oscillating motion with the relative rotary motion.

9. Device in accordance with claim 8, wherein the radial oscillating motion is synchronized with the relative rotary motion.

10. Device in accordance with claim 9, wherein the ratio F of the frequency of the oscillating motion to the rpm is
$$F = \frac{S / V}{S / V \pm 1} ,$$
in which S is the pitch of the thread in mm and V is the feed of the relative longitudinal motion in mm per revolution.

11. Device in accordance with claim 8, wherein the mechanical means for generating the radial oscillating motion is a cam plate.

12. Device in accordance with claim 11, wherein the lathe tool is set into radial oscillating motion by means of the cam plate.

13. Device in accordance with claim 11, further comprising a spring for elastically pressing a plunger carrying the lathe tool against the cam plate.

14. Device in accordance with claim 13, wherein the lathe tool is attached to a plunger, which is moved by the cam plate towards the workpiece against the spring action and returned under the action of the spring.

15. Process in accordance with claim 5, wherein the lathe tool is moved by the cam plate against a spring force of a spring.

16. Device in accordance with claim 9, wherein the mechanical means for generating the radial oscillating motion is a cam plate.

17. Device in accordance with claim 10, wherein the mechanical means for generating the radial oscillating motion is a cam plate.

18. Device in accordance with claim 12, further comprising a spring for elastically pressing a plunger carrying the lathe tool against the cam plate.

19. Device in accordance with claim 11, further comprising a spring for elastically pressing a plunger carrying the lathe tool against the cam plate, wherein the lathe tool is attached to a plunger, which is moved by the cam plate towards the workpiece against the spring action and returned under the action of the spring.

20. Device in accordance with claim 12, further comprising a spring for elastically pressing a plunger carrying the lathe tool against the cam plate, wherein the lathe tool is attached to a plunger, which is moved by the cam plate towards the workpiece against the spring action and returned under the action of the spring.
